(19) United States
(12) Patent Application Publication
(10) Pub. No.: US 2009/0129693 A1
(43) Pub. Date: May 21, 2009

(54) SYSTEM AND METHOD FOR GENERATING A PHOTOGRAPH WITH VARIABLE IMAGE QUALITY

(76) Inventors: L. Scott Bloebaum, Cary, NC (US); Ivan N. Wakefield, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/940,386

(22) Filed: Nov. 15, 2007

(51) Int. Cl. G06K 9/40; G06K 9/36

(52) U.S. Cl. 382/255; 382/232

(57) ABSTRACT

A method and system of quality management for a digital photograph includes using multi-zone autofocus information to generate an image file that has a high-quality portion and a low-quality portion. In one approach, captured image data is processed so that a portion of the image data corresponding to an area different than a focus zone is lower in quality than image data corresponding to an area inside the focus zone. In another approach, sensor resolution responsiveness is set higher for a sensor area corresponding to a focus zone than sensor resolution responsiveness in an area different than the sensor area corresponding to the focus zone.

### TECHNICAL FIELD OF THE INVENTION

The technology of the present disclosure relates generally to photography and, more particularly, to a system and method to achieve different degrees of image quality in a digital photograph.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. For example, many mobile telephones now include cameras that are capable of capturing still images and video images.

The imaging devices associated with many portable electronic devices are becoming easier to use and are capable of taking reasonably high-quality photographs. As a result, users are taking more photographs, which has caused an increased demand for data storage capacity of a memory of the electronic device. Although raw image data captured by the imaging device is often compressed so that an associated image file does not take up an excessively large amount of memory, there is room for improvement in the manner in which image data is managed. For instance, a five-megapixel image may require between one and two megabytes of storage capacity even when compressed, and the storage of many such large images eliminates a significant portion of common storage capacity that would otherwise be available to store data for other applications (e.g., store audio files for a music player application).

### SUMMARY

To improve the manner in which image data for a photograph is handled, the present disclosure describes an improved image quality management technique and system. The disclosure describes analyzing a scene to set the focus of the imaging device using an autofocus technique, such as multi-zone autofocus (MZAF). MZAF involves determining one or more areas of the scene upon which a focus setting of the imaging device is determined. The areas (or zones) of the scene that are used to determine the focus setting of the imaging device are also used to determine the quality of the image data across a corresponding photograph. For instance, image data associated with zones used to determine the focus setting may receive no compression or less compression and/or no down-sampling or less down-sampling that the remainder of the image data. As a result, the resulting image file may have higher quality in areas corresponding to the zones used to determine the focus setting than the remainder of the image file. In this manner, portions of the photograph that are likely to be of the most importance, as determined by the autofocus technique, will have higher quality than the remainder of the photograph. Also, since the remainder of the photograph has higher compression and/or lower resolution than the zones used to determine the focus setting, the size of the associated image file (e.g., in number of bytes) may be lower than if the image had been compressed or sampled uniformly. In this manner, the average image file size may be reduced to conserve memory space while maintaining the high quality of the image portion(s) that are likely to be of importance to the user of the imaging device. Additional techniques for quality management of image files based on autofocus data are disclosed.

According to one aspect of the disclosure, a method of generating image data for a scene includes setting resolution responsiveness of a sensor to generate image data with a first resolution responsiveness for a first area of the sensor and a second resolution responsiveness for a second area of the sensor that is different than the first area, the second resolution responsiveness being lower than the first resolution responsiveness; capturing image data corresponding to the scene with the sensor; and outputting the image data for the scene from the sensor, the output image data for the scene containing the image data corresponding to the first and second resolution responsiveness settings so that the image data for the scene has a high-quality portion corresponding to the first resolution responsiveness setting and a low-quality portion corresponding to the second resolution responsiveness setting.

According to one embodiment, the method further includes establishing a multi-zone autofocus parameter set that contains information regarding one or more zones of a scene upon which an autofocus setting for a camera assembly is based and setting the focus of the camera assembly based on the autofocus setting, and wherein the first area of the sensor corresponds to the one or more zones.

According to one embodiment of the method, the first resolution responsiveness of the sensor is less than the full resolution capability of the sensor.

According to one embodiment, the method further includes at least one of down-sampling or compressing the output image data.

According to one embodiment of the method, setting the resolution responsiveness further results in a third resolution responsiveness area adjacent the first resolution responsiveness area, the third resolution responsiveness being lower than the first resolution responsiveness and higher than the second resolution responsiveness.

According to one embodiment of the method, the third resolution responsiveness is graduated from the second resolution responsiveness to the first resolution responsiveness.

According to one embodiment of the method, the captured image data is scanned to generate high-resolution image data for the high-quality portion and separately scanned to generated low-resolution image data for the low-quality portion.

According to another aspect of the disclosure, a camera assembly for generating a digital image of a scene includes a sensor that outputs image data corresponding to the scene in accordance with a first resolution responsiveness for a first area of the sensor and a second resolution responsiveness for a second area of the sensor that is different than the first area, the second resolution responsiveness being lower than the first resolution responsiveness; and a memory that stores an image file for the scene, the image file containing the image data output by the sensor with the first and the second resolution responsiveness settings so that the image file has a high-quality portion corresponding to the first resolution responsiveness setting and a low-quality portion corresponding to the second resolution responsiveness setting.

According to one embodiment, the camera assembly further includes a multi-zone autofocus assembly that establishes a multi-zone autofocus parameter set that contains information regarding one or more zones of the scene upon which an autofocus setting for the camera assembly is based, and wherein the first area of the sensor corresponds to the one or more zones.

According to an embodiment of the camera assembly, the first resolution responsiveness of the sensor is less than the full resolution capability of the sensor.

According to an embodiment of the camera assembly, the captured image data is processed by at least one of compressing or down-sampling.

According to an embodiment of the camera assembly, the sensor is further controlled to output image data with a third resolution responsiveness in an area adjacent the first resolution responsiveness area, the third resolution responsiveness being lower than the first resolution responsiveness and higher than the second resolution responsiveness.

According to an embodiment of the camera assembly, the third resolution responsiveness is graduated from the second resolution responsiveness to the first resolution responsiveness.

According to an embodiment of the camera assembly, the sensor captures image data and scans the captured image data to generate high-resolution image data for the high-quality portion and separately scans the captured image data to generated low-resolution image data for the low-quality portion.

According to an embodiment of the camera assembly, the camera assembly forms part of a mobile telephone that includes call circuitry to establish a call over a network.

According to another aspect of the disclosure, a method of managing image data for a digital photograph includes establishing a multi-zone autofocus parameter set that contains information regarding one or more zones of a scene upon which an autofocus setting for a camera assembly is based; capturing image data corresponding to the scene with the camera assembly where a portion of the image data corresponds to the one or more zones and image data other than the portion corresponding to the one or more zones is a remainder portion of the image data; processing the remainder portion of the image data so that the remainder portion of the image data has a lower quality than the portion of the image data corresponding to the one or more zones; and storing an image file for the scene, the image file containing image data corresponding to the one or more zones and the processed remainder portion of the image data so that the image file has a high-quality portion and a low-quality portion.

According to one embodiment, the method further includes processing the image data corresponding to the one or more zones to reduce a quality of the image data corresponding to the one or more zones.

According to one embodiment of the method, processing the image data corresponding to the one or more zones includes down-sampling the image data.

According to one embodiment of the method, processing the image data corresponding to the one or more zones includes applying a compression algorithm.

According to one embodiment of the method, processing the remainder portion of the image data includes down-sampling the image data.

According to one embodiment of the method, processing the remainder portion of the image data includes applying a compression algorithm.

According to one embodiment, the method further includes processing image data adjacent the portion of the image data corresponding to the one or more zones such that the image file has an intermediate-quality portion corresponding to the adjacent image data, the intermediate-quality portion having a quality between the quality of the low-quality portion and the high-quality portion.

According to one embodiment of the method, the adjacent image data is processed to have a graduated quality from the quality of the low-quality portion to the quality of the high-quality portion.

According to another aspect of the disclosure, a camera assembly for taking a digital photograph includes a multi-zone autofocus assembly that establishes a multi-zone autofocus parameter set that contains information regarding one or more zones of a scene upon which an autofocus setting for the camera assembly is based; a sensor that captures image data corresponding to the scene where a portion of the image data corresponds to the one or more zones and image data other than the portion corresponding to the one or more zones is a remainder portion of the image data; a controller that processes the remainder portion of the image data so that the remainder portion of the image data has a lower quality than the portion of the image data corresponding to the one or more zones; and a memory that stores an image file for the scene, the image file containing image data corresponding to the one or more zones and the processed remainder portion of the image data so that the image file has a high-quality portion and a low-quality portion.

According to an embodiment of the camera assembly, the controller further processes the image data corresponding to the one or more zones to reduce a quality of the image data corresponding to the one or more zones.

According to an embodiment of the camera assembly, processing the remainder portion of the image data includes at least one of down-sampling the image data or applying a compression algorithm.

According to an embodiment of the camera assembly, the controller further processes image data adjacent the portion of the image data corresponding to the one or more zones such that the image file has an intermediate-quality portion corresponding to the adjacent image data, the intermediate-quality portion having a quality between the quality of the low-quality portion and the quality of the high-quality portion.

According to an embodiment of the camera assembly, the adjacent image data is processed to have a graduated quality from the quality of the low quality portion to the quality of the high-quality portion.

According to an embodiment of the camera assembly, the camera assembly forms part of a mobile telephone that includes call circuitry to establish a call over a network.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1 and 2 are respectively a front view and a rear view of an exemplary electronic device that includes a representative camera assembly;

FIG. 3 is a schematic block diagram of the electronic device of FIGS. 1 and 2;

FIG. 4 is a schematic diagram of a communications system in which the electronic device of FIGS. 1 and 2 may operate;

FIG. 5 is a schematic view of a representative scene that has been segmented into plural possible focus zones;

FIG. 6 is a schematic view of a representative image corresponding to the scene of FIG. 5 and that has variable image quality zones that correspond to autofocus information;

FIG. 7 is a schematic view of another representative image corresponding to the scene of FIG. 5 and that has variable image quality zones that correspond to autofocus information; and

FIG. 8 is a front view of a sensor for a camera assembly that has variable image quality zones corresponding to autofocus information.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved image quality management system and method. In the illustrated embodiments, quality management is carried out by a device that includes a digital camera assembly used to capture image data in the form of still images, also referred to as photographs. It will be understood that the image data may be captured by one device and then transferred to another device that carries out the quality management. It also will be understood that the camera assembly may be capable of capturing video images in addition to still images.

The quality management will be primarily described in the context of managing image data generated by a digital camera that is made part of a mobile telephone. It will be appreciated that the quality management may be used in other operational contexts such as, but not limited to, a dedicated camera, another type of electronic device that has a camera (e.g., a personal digital assistant (PDA), a media player, a gaming device, a “web” camera, a computer, etc.), and so forth.

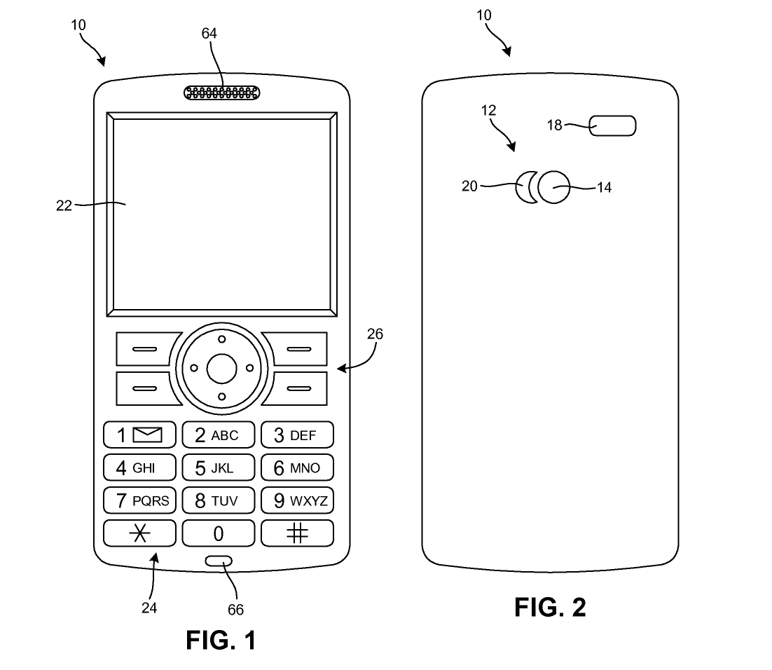

Referring initially to FIGS. 1 and 2, an electronic device 10 is shown. The illustrated electronic device 10 is a mobile telephone. The electronic device 10 includes a camera assembly 12 for taking digital still pictures and/or digital video clips. It is emphasized that the electronic device 10 need not be a mobile telephone, but could be a dedicated camera or some other device as indicated above

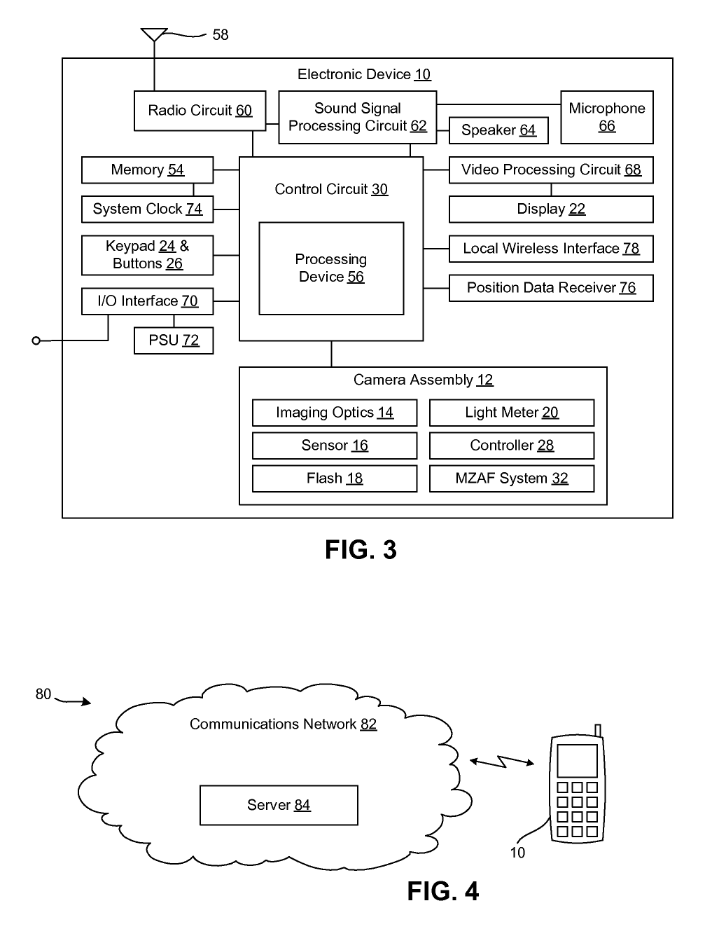

With additional reference to FIG. 3, the camera assembly 12 may be arranged as a typical camera assembly that includes imaging optics 14 to focus light from a scene within the field of view of the camera assembly 12 onto a sensor 16. The sensor 16 converts the incident light into image data that may be processed using the techniques described in this disclosure. The imaging optics 14 may include a lens assembly and components that that supplement the lens assembly, such as a protective window, a filter, a prism, a mirror, focusing mechanics, and optical zooming mechanics. Other camera assembly 12 components may include a flash 18, a light meter 20, a display 22 for functioning as an electronic viewfinder and as part of an interactive user interface, a keypad 24 and/or buttons 26 for accepting user inputs, an optical viewfinder (not shown), and any other components commonly associated with cameras.

Another component of the camera assembly 12 may be an electronic controller 28 that controls operation of the camera assembly 12. The controller 28, or a separate circuit (e.g., a dedicated image data processor), may carry out the quality management. The electrical assembly that carries out the quality management may be embodied, for example, as a processor that executes logical instructions that are stored by an associated memory, as firmware, as an arrangement of dedicated circuit components or as a combination of these embodiments. Thus, the quality management technique may be physically embodied as executable code (e.g., software) that is stored on a machine readable medium or the quality management technique may be physically embodied as part of an electrical circuit. In another embodiment, the functions of the electronic controller 28 may be carried out by a control circuit 30 that is responsible for overall operation of the electronic device 10. In this case, the controller 28 may be omitted. In another embodiment, camera assembly 12 control functions may be distributed between the controller 28 and the control circuit 30.

The camera assembly 12 may further include components to adjust the focus of the camera assembly 12 depending on objects in the scene and their relative distances to the camera assembly 12. In one embodiment, these components may comprise a multi-zone autofocus (MZAF) system 32. Processing to make MZAF determinations may be carried out by the controller 28 that works in conjunction with the MZAF system 32 components. The MZAF system 32 may include, for example, a visible light or infrared light emitter, a coordinating light detector, and an autoranging circuit. By way of example, a rudimentary MZAF system that may be suitable for use in the camera assembly 12 is disclosed in U.S. Pat. No. 6,275,658.

The basic operating principle of an MZAF system is that the MZAF system detects object distances in multiple areas (referred to as zones) of the image frame. From the detected information, the MZAF may compute a compromise focus position for the imaging optics that accommodates for the various detected distances in one or more selected zones. In many implementations, MZAF identifies the main feature or features in the scene (e.g., faces, objects at a common distance, objects that are centered in the scene, etc.) and selects zones of the image that correspond to the main features. Furthermore, the distance of the object(s) in the selected zone(s) are used to determine a single focus setting for the current image frame. In effect, the camera assembly 12 determines the number, size and dimensions of area(s) within the scene that are likely to be of high importance to the user. The number, size and dimensions of the area or areas selected to determine the focus setting of the camera assembly 12 may be referred to as an MZAF parameter set. In conventional camera assemblies that use MZAF, the MZAF parameter set is discarded after the focus of the imaging optics is established and is not used for tasks other than setting the focus.

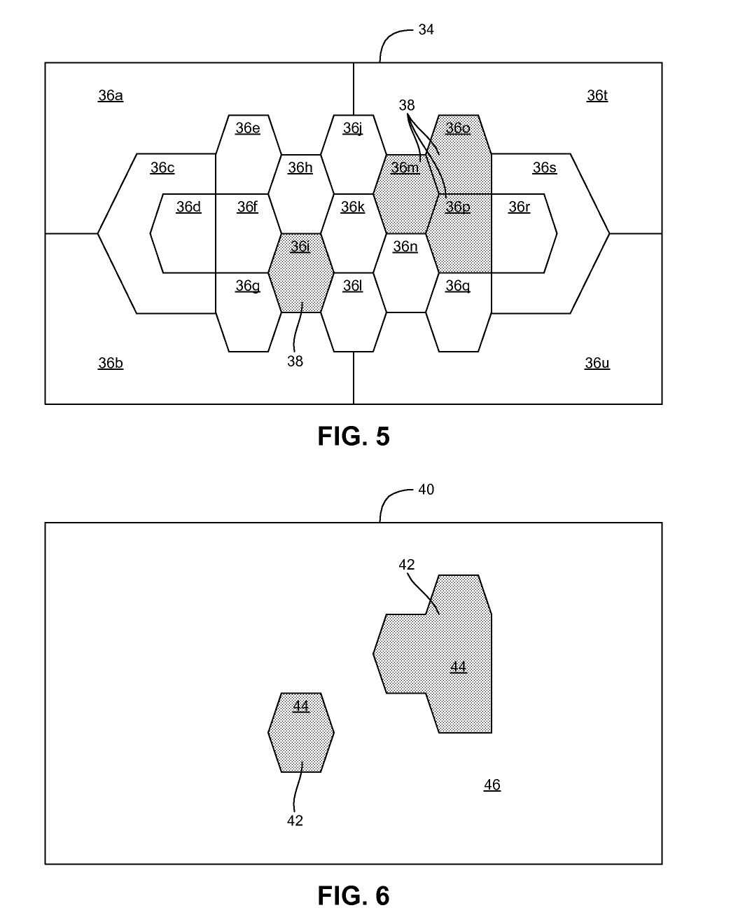

With additional reference to FIG. 5, shown is a schematic representation of a scene 34 from the vantage point of the camera assembly 12. The MZAF system 32 may logically segment the scene 34 into a number of zones 36. In the illustrated example, there are twenty one zones 36, which have been labeled 36a through 36u. It will be understood that the illustrated twenty one zones 36 are exemplary and there may be a different number of zones 36 and/or the zones 36 may have different sizes, shapes and relative positioning with respect to the scene 34.

The objects in the scene may be analyzed to determine an appropriate focus for the imaging optics 14. For instance, using an MZAF analysis based on the relative distances of the objects in the scene and/or object identification (e.g., facial feature recognition), the MZAF system 32 may ascertain which zones 36 contain objects upon which a focus determination should be based. In the illustrated example, four zones 36 have been identified as being associated with an object (or objects) having a distance from the camera assembly 12 to base the focus setting for the imaging optics 14. In the example of FIG. 5, the identified zones have been shaded and labeled as identified zones 38. The identified zones 38 of the illustrated example correspond to zones 36i, 36m, 36o and 36p. It will be appreciated that the illustration of four identified zones 38 is exemplary and that more than or less then four zones may be used to make the focus determination. Also, if plural zones 36 are identified for use in the determination of the focus setting, the identified zones 36 may be contiguous or non-contiguous. It will be understood that the number and location of the identified zones 38 will vary depending on the objects contained in any particular scene 34.

In the illustrated example, the identified zone(s) 38 are a subset of the zones 36, where each zone 36 has a predetermined configuration in terms of size, shape and location relative to the scene 34. In other embodiments, analysis of the scene 34 may lead to the establishment of an identified zone 38 (or identified zones 38) that has a custom size, shape and location to correspond to one or more objects in the scene 34. In these embodiments, the identified zone 38 is not based on predetermined zone(s) 36 but has a size, shape and location that is configured for the objects in the scene 34. In either case, the size, shape and location of the identified zone(s) 38 define a MZAF parameter set. The MZAF parameter set, therefore, contains information about the size, shape and location of the identified zone(s) 38 upon which the focus setting of the camera assembly 12 is based.

Once the focus determination has been made using the distance of the objects located in the identified zone(s) 38, the imaging optics 14 may be adjusted to impart the desired focus setting to the camera assembly 12. In addition, the MZAF parameter set (e.g., information about the size, shape and location of the identified zone(s) 38 upon which the focus setting of the camera assembly 12 is based) is retained for quality management of a corresponding image.

As will now be described, the MZAF parameter set may be used in different manners to manage quality of an image. In one embodiment, the MZAF parameter set may be used during post-capture compression of image data. The post-capture compression may be carried out by the controller 28, for example. In another embodiment, the MZAF parameter set may be used to selectively adjust resolution of image data that is generated by the sensor 16. Resolution management may be carried out by the controller 28, for example. In another embodiment, the quality management may include both resolution management and compression.

With additional reference to FIG. 6, schematically illustrated is a representative image 40 corresponding to the scene 34 of FIG. 5. In the embodiment of FIG. 6, the MZAF parameter set is used to compress the image data associated with the image 40. In particular, the pixels that fall within an area (or areas) 42 of the image 40 corresponding to the zones 38 may be compressed using a lower compression ratio than pixels that fall outside the area(s) 42. For simplicity, the ensuing description will refer to an area 42 (or portion) in the singular, but the reader should understand that the description of an area 42 (or portion) in the singular explicitly includes one or more than one areas (or portions) of the image. Therefore, the area 42 may be contiguous or non-contiguous.

The area 42 receiving lower compression will have higher image quality relative to the remaining portion of the image that receives more compression. As a result, the image data is processed so that the corresponding image file has a high-quality component and a low-quality component. For instance, the processing of the image data may involve applying no compression to the pixels associated with the area 42 or the processing of the image data may involve applying some compression to the pixels associated with the area 42. The processing of the image data may further involve applying compression to the pixels outside the area 42 with a compression ratio that is higher than the compression ratio that is applied to the pixels inside the area 42.

Compression of the image data may include any appropriate compression technique, such as applying an algorithm that changes the effective amount of the image data in terms of number of bits per pixel. Compression algorithms include, for example, a predetermined compression technique for the file format that will be used to store the image data. One type of file specific compression is JPEG compression, which includes applying one of plural “levels” of compression ranging from a most lossy JPEG compression through intermediate JPEG compression levels to a highest-quality JPEG compression. For example, a lowest quality JPEG compression may have a quality value (or Q value) of one, a low-quality JPEG compression may have a Q value of ten, a medium quality JPEG compression may have a Q value of twenty-five, an average quality JPEG compression may have a Q value of fifty, and a full quality JPEG compression may have a Q value of one hundred. In one embodiment, full or average JPEG compression may be applied to the image data corresponding to the area 42 and low or medium JPEG compression may be applied to the image data outside the area 42.

In an embodiment of managing the image quality, the resolution (or number of pixels per unit area) may be controlled. One technique for controlling the resolution is to down-sample (also referred to as sub-sample) the raw image data that is output by the sensor 16. As used herein, down-sampling refers to any technique to reduce the number of pixels per unit area of the image frame such that a lower amount of resolution is retained after processing than before processing.

As an example, the sensor 16 may have a native resolution of five megapixels. For the image data falling inside the area 42, the quality management may retain the full resolution of the image data output by the sensor 16. Alternatively, the quality management may retain a high amount (e.g., percentage) of this image data, but an amount that is less than the full resolution of the image data output by the sensor 16. For example, the retained data may result in an effective resolution of about 60 percent to about 90 percent of the full resolution. As a more specific example using the exemplary five-megapixel sensor, the retained image data may be an amount of data corresponding to a four-megapixel sensor (or about 80 percent of the image data output by the exemplary five-megapixel sensor). In one embodiment, a combined approach may be taken where all or some of the full resolution image data may be retained and a selected compression level may be applied to the image data.

For the image data falling outside the area 42, the quality management may retain a relatively low amount (e.g., percentage) of the image data output by the sensor 16. For example, the retained data may result in an effective resolution of about 10 percent to about 50 percent of the full resolution. As a more specific example using the exemplary five-megapixel sensor, the retained image data may be an amount of data corresponding to a one-megapixel sensor (or about 20 percent of the image data output by the exemplary five-megapixel sensor). In one embodiment, a combined approach may be taken where some of the full resolution image data may be retained and a selected compression level may be applied to the image data.

The result of managing the resolution and/or compression differently for the area 42 and the remainder of the image 40 is to establish a resultant image that has variable image quality regions, and where the different quality regions correspond to autofocus information. In particular, a first portion 44 of the image has a first quality level based on the quality management applied to the area 42 and a second portion 46 of the image has a second quality level, where the first quality level is higher than the second quality level in terms of number of pixels per unit area of the image frame and/or number of bits per pixel. It is contemplated that the associated image file may have a smaller file size than if the entire image were uniformly compressed and/or down-sampled using a single image data management technique to maintain a reasonably high level of quality for the entire image. In addition to the smaller file size, the first portion of the image that has the higher quality is likely to coincide with objects in the imaged scene that are in focus since the quality management and the focus setting are determined jointly from the same MZAF parameter set. In this regard, if the autofocus determination for the camera assembly is based on objects that are likely to be of greatest interest to the user, then the corresponding portion(s) of the image also will have the highest quality. It will be recognized that the first portion 44 and/or the second portion 46 need not be contiguous.

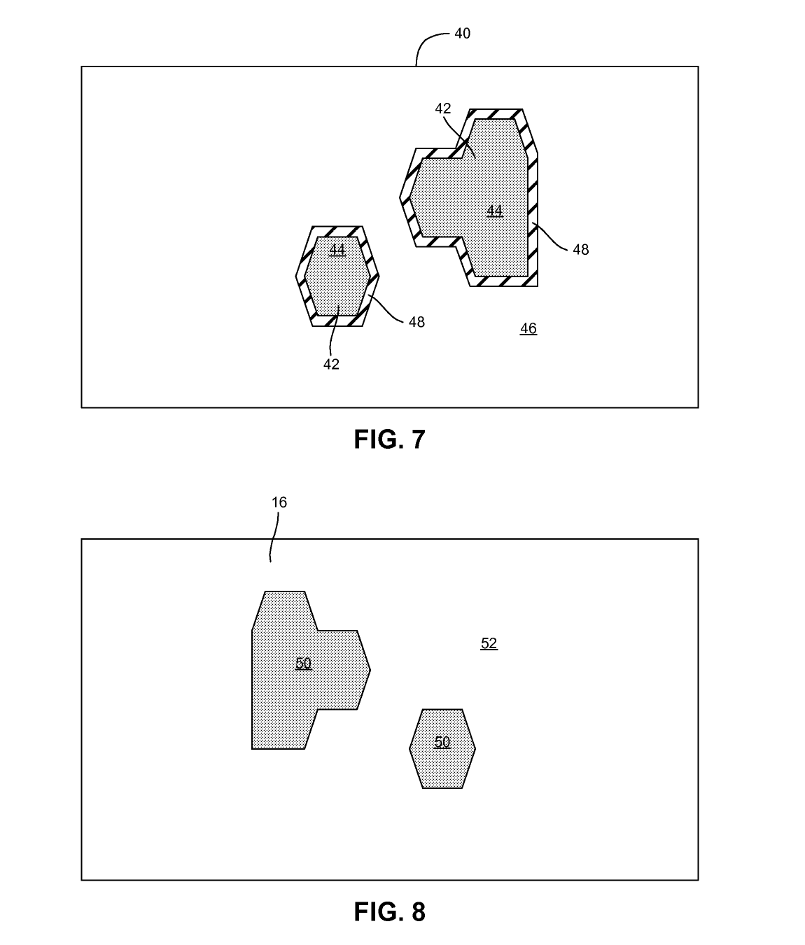

With additional reference to FIG. 7, more than two quality levels may be used. In the exemplary illustration of FIG. 7, shown is the image 40 having the high-quality portion 44 and the low-quality portion 46. In addition, one or more intermediate resolution quality 48 may be created by appropriate processing of the image data, such as retaining some of the raw image data (e.g., about 20 to about 75 percent of the image data) and/or applying a selected compression level to the image data. As a more specific example that follows from the forgoing example of a five-megapixel sensor 16, the retained image data for the intermediate-quality portion 48 may be an amount of data corresponding to a two-megapixel sensor (or about 40 percent of the image data output by the exemplary five-megapixel sensor). In other example, a moderately lossy JPEG compression level may be selected for the intermediate-quality portion 48. Similar to the high-quality portion 44, the intermediate-quality portion 48 need not be contiguous.

In the illustrated embodiment, pixels that are outside the area 42 and adjacent the area 42 are compressed using a compression ratio that is between the compression ratio applied to the area 42 and the compression ratio applied to the remainder of the image 40. In another embodiment, the resolution of the image data that is outside the area 42 and adjacent the area 42 may be managed to have a resolution between the resolution of the area 42 and the resolution of the remainder of the image 40. In this manner, the high-quality portion 44 is surrounded by the intermediate-quality portion 48, where the intermediate-quality portion 48 has higher quality than the low-quality portion 46 but less quality than the high-quality portion 44. It will be appreciated that the intermediate-quality portion 48 does not need to surround the high-quality portion 44. In other embodiments, the intermediate-quality portion 48 may have a fixed location, such as a center region of the image. As also will be appreciated, there may be plural intermediate portions where each has a different amount of quality.

In another embodiment, the intermediate-quality portion 48 may have graduated quality. For instance, the quality in the intermediate-quality portion 48 may progressively taper from the high quality of the high-quality portion 44 to the low quality of the low-quality portion 46 so as to blend the high-quality portion 44 into the low-quality portion 46.

In the embodiments described thus far, the camera assembly 12 may process the full set of image data output by the sensor 16 for a given photograph. Thereafter, post-capture processing of the image data is used to selectively compress the “raw” image data and/or change the resolution of the “raw” image data in accordance with the autofocus information to achieve the high-quality portion 44, the low-quality portion 46 and, if present, the intermediate-quality portion 46. Another quality management technique may involve using the MZAF parameter set to selectively adjust resolution responsiveness of the sensor 16. Also, the post-capture processing may be combined with the sensor 16 adjustment technique.

With addition reference to FIG. 8, shown is a front view of the sensor 16. The sensor is controlled to have a first resolution responsiveness area 50 that corresponds to the MZAF parameter set. For purposes of an example, the MZAF parameter set that is used to define the illustrated area 50 in FIG. 8 corresponds to the identified zones 38 from FIG. 5. Since the vantage point of the sensor 16 in FIG. 8 is a front view and the vantage point of the scene 34 in FIG. 5 is from the camera assembly, the area 50 is illustrated as a mirror image of the combination of the identified zones 38. Depending on the arrangement of the sensor 16 and other components of the camera assembly, the area 50 may not always be a mirror image of the identified zones 38. Also, the area 50 need not be contiguous.

To implement the embodiment of FIG. 8, the sensor 16 may be configured to react to control signals from the controller 28 so that the sensor 16 outputs image data with one resolution for the area 50 and a different resolution for other portions of the image field. For this purpose, the sensor may include logic and control components to generate output image data with different resolution portions.

In one approach, the sensor may make multiple scans of a preliminary image data set. The preliminary data set may be obtained by imaging the image field at a high resolution. A first scan may decode a portion of the preliminary data set corresponding to the area 50 to generate high resolution image data and a second scan (separate from the first scan) may decode a portion of the preliminary data set for other portions of the sensor to generate low resolution image data. The low and high resolution image data may be merged and then output by the sensor as image data for the image field.

In the embodiment of FIG. 8, the resolution responsiveness of the sensor 16 in the area 50 may be controlled to be relatively high, such as about 60 percent to about 100 percent of the full resolution capability of the sensor 16. For instance, if the maximum resolution capacity of the sensor 16 is five megapixels, the resolution of the sensor 16 in the area 50 may be set to produce image data at a rate corresponding to about a three-megapixel sensor to about a five-megapixel sensor. The resolution responsiveness of a remainder area 52 of the sensor 16 (e.g., at least a portion of the sensor 16 different than the area 50) may be controlled to be relatively low, such as about 10 percent to about 60 percent of the full resolution capability of the sensor 16. For example, in one embodiment, the remainder area 52 may be controlled to produce image data at a rate corresponding to about 20 percent of the resolution capacity of the senor 16. If the exemplary five-megapixel sensor were used to produce image data at 20 percent of the maximum capacity of the sensor 16, then the image data corresponding to the area 52 would have a resolution equivalent to about a one-megapixel sensor. Continuing to follow this example, when the image data from the area 50 and the area 52 are combined to form an image file, the image data within the associated image file will have an average resolution of less than the maximum five-megapixel resolution of the exemplary sensor. In effect, the image data stored by the corresponding image file may be considered to have variable image quality without post-capture processing of the image data.

An additional contiguous or non-contiguous portion of the sensor 16 may be controlled to generate image data having a resolution between the resolution of the area 50 and the resolution of the area 52. In this manner, the corresponding image data for a photograph of the scene 34 may have a high-quality component corresponding to image data generated by the sensor 16 in the area 50, a low-quality component corresponding to image data generated by the sensor 16 in the area 52 and an intermediate-quality component corresponding to image data generated by the sensor 16 in the additional area dedicated to the intermediate resolution. Similar to the embodiment of FIG. 7, the intermediate sensor resolution responsiveness may surround the area 50, may correspond to a predetermine portion of the field of the view of the camera assembly 12 and/or may have a graduated resolution.

In one embodiment, image quality management carried out by the camera assembly 12 may be a default setting such that photographs generated by the camera assembly 12 have plural image quality areas. In another embodiment, the image quality management may be turned on or off by the user. In yet another embodiment, the user may have control over how image quality management is implemented (e.g., post-capture processing of image data or changing the sensor resolution responsiveness), control over the post-capture processing technique (e.g., data retention or compression algorithm), and/or control over the relative amounts of quality as a function of resolution and/or compression that are used for each portion of the image.

As indicated, the illustrated electronic device 10 shown in FIGS. 1 and 2 is a mobile telephone. Features of the electronic device 10, when implemented as a mobile telephone, will be described with additional reference to FIG. 3. The electronic device 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

As indicated, the electronic device 10 may include the display 22. The display 22 displays information to a user such as operating state, time, telephone numbers, contact information, various menus, etc., that enable the user to utilize the various features of the electronic device 10. The display 22 also may be used to visually display content received by the electronic device 10 and/or retrieved from a memory 54 of the electronic device 10. The display 22 may be used to present images, video and other graphics to the user, such as photographs, mobile television content and video associated with games.

The keypad 24 and/or buttons 26 may provide for a variety of user input operations. For example, the keypad 24 may include alphanumeric keys for allowing entry of alphanumeric information such as telephone numbers, phone lists, contact information, notes, text, etc. In addition, the keypad 24 and/or buttons 26 may include special function keys such as a “call send” key for initiating or answering a call, and a “call end” key for ending or “hanging up” a call. Special function keys also may include menu navigation and select keys to facilitate navigating through a menu displayed on the display 22. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, etc. Keys or key-like functionality also may be embodied as a touch screen associated with the display 22. Also, the display 22 and keypad 24 and/or buttons 26 may be used in conjunction with one another to implement soft key functionality. As such, the display 22, the keypad 24 and/or the buttons 26 may be used to control the camera assembly 12.

The electronic device 10 may include call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 54, executing applications to allow user interaction with the data, displaying video and/or image content associated with the data, outputting audio sounds associated with the data, and so forth.

The electronic device 10 may include the primary control circuit 30 that is configured to carry out overall control of the functions and operations of the electronic device 10. As indicated, the control circuit 30 may be responsible for controlling the camera assembly 12, including the quality management of photographs.

The control circuit 30 may include a processing device 56, such as a central processing unit (CPU), microcontroller or microprocessor. The processing device 56 may execute code that implements the various functions of the electronic device 10. The code may be stored in a memory (not shown) within the control circuit 30 and/or in a separate memory, such as the memory 54, in order to carry out operation of the electronic device 10. It will be apparent to a person having ordinary skill in the art of computer programming, and specifically in application programming for mobile telephones or other electronic devices, how to program a electronic device 10 to operate and carry out various logical functions.

Among other data storage responsibilities, the memory 54 may be used to store photographs and/or video clips that are captured by the camera assembly 12. Alternatively, the images may be stored in a separate memory. The memory 54 may be, for example, one or more of a buffer, a flash memory, a hard drive, a removable media, a volatile memory, a non-volatile memory, a random access memory (RAM), or other suitable device. In a typical arrangement, the memory 54 may include a non-volatile memory (e.g., a NAND or NOR architecture flash memory) for long term data storage and a volatile memory that functions as system memory for the control circuit 30. The volatile memory may be a RAM implemented with synchronous dynamic random access memory (SDRAM), for example. The memory 54 may exchange data with the control circuit 30 over a data bus. Accompanying control lines and an address bus between the memory 54 and the control circuit 30 also may be present.

Continuing to refer to FIGS. 1 through 3, the electronic device 10 includes an antenna 58 coupled to a radio circuit 60. The radio circuit 60 includes a radio frequency transmitter and receiver for transmitting and receiving signals via the antenna 58. The radio circuit 60 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 58 and the radio circuit 60 may represent one or more than one radio transceivers.

The electronic device 10 further includes a sound signal processing circuit 62 for processing audio signals transmitted by and received from the radio circuit 60. Coupled to the sound processing circuit 62 are a speaker 64 and a microphone 66 that enable a user to listen and speak via the electronic device 10 as is conventional. The radio circuit 60 and sound processing circuit 62 are each coupled to the control circuit 30 so as to carry out overall operation. Audio data may be passed from the control circuit 30 to the sound signal processing circuit 62 for playback to the user. The audio data may include, for example, audio data from an audio file stored by the memory 54 and retrieved by the control circuit 30, or received audio data such as in the form of streaming audio data from a mobile radio service. The sound processing circuit 62 may include any appropriate buffers, decoders, amplifiers and so forth.

The display 22 may be coupled to the control circuit 30 by a video processing circuit 68 that converts video data to a video signal used to drive the display 22. The video processing circuit 68 may include any appropriate buffers, decoders, video data processors and so forth. The video data may be generated by the control circuit 30, retrieved from a video file that is stored in the memory 54, derived from an incoming video data stream that is received by the radio circuit 60 or obtained by any other suitable method. Also, the video data may be generated by the camera assembly 12 (e.g., such as a preview video stream to provide a viewfinder function for the camera assembly 12).

The electronic device 10 may further include one or more I/O interface(s) 70. The I/O interface(s) 70 may be in the form of typical mobile telephone I/O interfaces and may include one or more electrical connectors. As is typical, the I/O interface(s) 70 may be used to couple the electronic device 10 to a battery charger to charge a battery of a power supply unit (PSU) 72 within the electronic device 10. In addition, or in the alternative, the I/O interface(s) 70 may serve to connect the electronic device 10 to a headset assembly (e.g., a personal handsfree (PHF) device) that has a wired interface with the electronic device 10. Further, the I/O interface(s) 70 may serve to connect the electronic device 10 to a personal computer or other device via a data cable for the exchange of data. The electronic device 10 may receive operating power via the I/O interface(s) 70 when connected to a vehicle power adapter or an electricity outlet power adapter. The PSU 72 may supply power to operate the electronic device 10 in the absence of an external power source.

The electronic device 10 also may include a system clock 74 for clocking the various components of the electronic device 10, such as the control circuit 30 and the memory 54.

The electronic device 10 also may include a position data receiver 76, such as a global positioning system (GPS) receiver, Galileo satellite system receiver or the like. The position data receiver 76 may be involved in determining the location of the electronic device 10.

The electronic device 10 also may include a local wireless interface 78, such as an infrared transceiver and/or an RF interface (e.g., a Bluetooth interface), for establishing communication with an accessory, another mobile radio terminal, a computer or another device. For example, the local wireless interface 78 may operatively couple the electronic device 10 to a headset assembly (e.g., a PHF device) in an embodiment where the headset assembly has a corresponding wireless interface.

With additional reference to FIG. 4, the electronic device 10 may be configured to operate as part of a communications system 80. The system 80 may include a communications network 82 having a server 84 (or servers) for managing calls placed by and destined to the electronic device 10, transmitting data to the electronic device 10 and carrying out any other support functions. The server 84 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 82 may support the communications activity of multiple electronic devices 10 and other types of end user devices. As will be appreciated, the server 84 may be configured as a typical computer system used to carry out server functions and may include a processor configured to execute software containing logical instructions that embody the functions of the server 84 and a memory to store such software.

Although certain embodiments have been shown and described, it is understood that equivalents and modifications falling within the scope of the appended claims will occur to others who are skilled in the art upon the reading and understanding of this specification.

What is claimed is:

1. A method of generating image data for a scene, comprising:
setting resolution responsiveness of a sensor to generate image data with a first resolution responsiveness for a first area of the sensor and a second resolution responsiveness for a second area of the sensor that is different than the first area, the second resolution responsiveness being lower than the first resolution responsiveness;
capturing image data corresponding to the scene with the sensor; and
outputting the image data for the scene from the sensor, the output image data for the scene containing the image data corresponding to the first and second resolution responsiveness settings so that the image data for the scene has a high-quality portion corresponding to the first resolution responsiveness setting and a low-quality portion corresponding to the second resolution responsiveness setting.

2. The method of claim 1, further comprising establishing a multi-zone autofocus parameter set that contains information regarding one or more zones of the scene upon which an autofocus setting for a camera assembly is based and setting the focus of the camera assembly based on the autofocus setting, and wherein the first area of the sensor corresponds to the one or more zones.

3. The method of claim 1, wherein the first resolution responsiveness of the sensor is less than the full resolution capability of the sensor.

4. The method of claim 1, further comprising at least one of down-sampling or compressing the output image data.

5. The method of claim 1, wherein setting the resolution responsiveness further results in a third resolution responsiveness area adjacent the first resolution responsiveness area, the third resolution responsiveness being lower than the first resolution responsiveness and higher than the second resolution responsiveness.

6. The method of claim 5, wherein the third resolution responsiveness is graduated from the second resolution responsiveness to the first resolution responsiveness.

7. The method of claim 1, wherein the captured image data is scanned to generate high-resolution image data for the high-quality portion and separately scanned to generated low-resolution image data for the low-quality portion.

8. A camera assembly for generating a digital image of a scene, comprising:
a sensor that outputs image data corresponding to the scene in accordance with a first resolution responsiveness for a first area of the sensor and a second resolution responsiveness for a second area of the sensor that is different than the first area, the second resolution responsiveness being lower than the first resolution responsiveness; and
a memory that stores an image file for the scene, the image file containing the image data output by the sensor with the first and the second resolution responsiveness settings so that the image file has a high-quality portion corresponding to the first resolution responsiveness setting and a low-quality portion corresponding to the second resolution responsiveness setting.

9. The camera assembly of claim 8, further comprising a multi-zone autofocus assembly that establishes a multi-zone autofocus parameter set that contains information regarding one or more zones of the scene upon which an autofocus setting for the camera assembly is based, and wherein the first area of the sensor corresponds to the one or more zones.

10. The camera assembly of claim 8, wherein the first resolution responsiveness of the sensor is less than the full resolution capability of the sensor.

11. The camera assembly of claim 8, wherein the output image data is processed by at least one of compressing or down-sampling.

12. The camera assembly of claim 8, wherein the sensor is further controlled to output image data with a third resolution responsiveness in an area adjacent the first resolution responsiveness area, the third resolution responsiveness being lower than the first resolution responsiveness and higher than the second resolution responsiveness.

13. The camera assembly of claim 12, wherein the third resolution responsiveness is graduated from the second resolution responsiveness to the first resolution responsiveness.

14. The camera assembly of claim 8, wherein the sensor captures image data and scans the captured image data to generate high-resolution image data for the high-quality portion and separately scans the captured image data to generated low-resolution image data for the low-quality portion.

15. The camera assembly of claim 8, wherein the camera assembly forms part of a mobile telephone that includes call circuitry to establish a call over a network.

16. A method of managing image data for a digital photograph, comprising:
establishing a multi-zone autofocus parameter set that contains information regarding one or more zones of a scene upon which an autofocus setting for a camera assembly is based;
capturing image data corresponding to the scene with the camera assembly where a portion of the image data corresponds to the one or more zones and image data other than the portion corresponding to the one or more zones is a remainder portion of the image data;
processing the remainder portion of the image data so that the remainder portion of the image data has a lower quality than the portion of the image data corresponding to the one or more zones; and
storing an image file for the scene, the image file containing image data corresponding to the one or more zones and the processed remainder portion of the image data so that the image file has a high-quality portion and a low-quality portion.

17. The method of claim 16, further comprising processing the image data corresponding to the one or more zones to reduce a quality of the image data corresponding to the one or more zones.

18. The method of claim 17, wherein processing the image data corresponding to the one or more zones includes down-sampling the image data.

19. The method of claim 17, wherein processing the image data corresponding to the one or more zones includes applying a compression algorithm.

20. The method of claim 16, wherein processing the remainder portion of the image data includes down-sampling the image data.

21. The method of claim 16, wherein processing the remainder portion of the image data includes applying a compression algorithm.

22. The method of claim 16, further comprising processing image data adjacent the portion of the image data corresponding to the one or more zones such that the image file has an intermediate-quality portion corresponding to the adjacent image data, the intermediate-quality portion having a quality between the quality of the low-quality portion and the high-quality portion.

23. The method of claim 22, wherein the adjacent image data is processed to have a graduated quality from the quality of the low-quality portion to the quality of the high-quality portion.

24. A camera assembly for taking a digital photograph, comprising:
a multi-zone autofocus assembly that establishes a multi-zone autofocus parameter set that contains information regarding one or more zones of a scene upon which an autofocus setting for the camera assembly is based;
a sensor that captures image data corresponding to the scene where a portion of the image data corresponds to the one or more zones and image data other than the portion corresponding to the one or more zones is a remainder portion of the image data;
a controller that process the remainder portion of the image data so that the remainder portion of the image data has a lower quality than the portion of the image data corresponding to the one or more zones; and
a memory that stores an image file for the scene, the image file containing image data corresponding to the one or more zones and the processed remainder portion of the image data so that the image file has a high-quality portion and a low-quality portion.

25. The camera assembly of claim 24, wherein the controller further processes the image data corresponding to the one or more zones to reduce a quality of the image data corresponding to the one or more zones.

26. The camera assembly of claim 24, wherein processing of the remainder portion of the image data includes at least one of down-sampling the image data or applying a compression algorithm.

27. The camera assembly of claim 24, wherein the controller further processes image data adjacent the portion of the image data corresponding to the one or more zones such that the image file has an intermediate-quality portion corresponding to the adjacent image data, the intermediate-quality portion having a quality between the quality of the low-quality portion and the quality of the high-quality portion.

28. The camera assembly of claim 27, wherein the adjacent image data is processed to have a graduated quality from the quality of the low-quality portion to the quality of the high-quality portion.

29. The camera assembly of claim 24, wherein the camera assembly forms part of a mobile telephone that includes call circuitry to establish a call over a network.
